(19) United States
(12) Patent Application Publication
(10) Pub. No.: US 2012/0256881 A1
(43) Pub. Date: Oct. 11, 2012

(54) DISPLAY DEVICE, DISPLAY METHOD, DISPLAY PROGRAM, RECORDING MEDIUM

(75) Inventor: Akizumi Fujioka, Osaka (JP)

(73) Assignee: Sharp Kabushiki Kaisha, Osaka (JP)

(21) Appl. No.: 13/515,676

(22) PCT Filed: Aug. 31, 2010
(86) PCT No.: PCT/JP2010/064835

§ 371 Date: Jun. 13, 2012

(30) Foreign Application Priority Data
Dec. 15, 2009 (JP) 2009-284286

(51) Int. Cl. G09G 3/36; G06F 3/042

(52) U.S. Cl. 345/175; 345/102

(57) ABSTRACT

A display device (1000) includes: a liquid crystal panel with built-in sensors (200) including a light sensor circuit (212); a detected information analyzing unit (130) detecting the location on the front surface of a panel (200) touched by an object based on the light intensity distribution detected by the light sensor circuit (212); an IR backlight (310) projecting light individually to the upper half and lower half of the panel surface from behind; a recognition area control circuit (110) obtaining a recognition area data specifying whether the location on the upper half of the panel surface or the lower half of the panel surface that is touched by an object is subjected to detection by a detected information analyzing unit (130); and a BL control unit (111) instructing the IR backlight (310) to project a smaller amount of light to a region specified in the recognition area data as not being subjected to location detection by the detected information analyzing unit (130).

### TECHNICAL FIELD

The present invention relates to a display device including a display panel equipped with a light sensor and to a display method.

### BACKGROUND ART

In recent years, electronic devices that allows data entry by touching display screens to specify locations have spread rapidly. Among those electronic devices, display devices having multiple light sensors on the display panel are gaining in popularity.

Display devices equipped with light sensors fall into two types: those detecting the shadow of an object such as a pen or a finger against the ambient light, and those detecting the transmitted light projected from the backlight of a liquid crystal panel and then reflected by an object. Devices that perform the reflected light detection are further categorized into two types: those using the backlight for image display to detect the reflected light, and those equipped with an infrared backlight, in addition to the backlight for image display, and detect the reflected infrared light emitted from the infrared backlight.

The problem with the system where an infrared backlight is provided in addition to the backlight for image display to detect the reflected infrared light is higher power consumption due to the infrared backlight, compared to the system where the backlight for image display is used to detect the reflected light.

Patent Document 1 discloses a display device, which backlight can consume less power than conventional display devices.

Specifically, the display device disclosed in Patent Document 1 has a low power consumption mode in addition to the regular operation mode in which the backlight is turned on with a prescribed luminance. In the low power consumption mode, the backlight is turned off, or is dimmed below the regular display mode level. Also, the display device of Patent Document 1 is configured to enter the low power consumption mode when no object such as a pen or a finger is detected approaching or touching the screen for a specified time period during the normal operation mode, and is configured to enter the normal operation mode when an object such as a pen or a finger is detected approaching or touching the screen during the lower power consumption mode.

### RELATED ART DOCUMENTS

### Patent Documents

Patent Document 1: Japanese Patent Application Laid-Open Publication No. 2007-163891 (published on Jun. 28, 2007)

### SUMMARY OF THE INVENTION

### Problems to be Solved by the Invention

However, as described below, the above-mentioned conventional configuration has a problem that while a user is touching the display screen to use the application, the backlight power consumption cannot be reduced.

That is, the display device of Patent Document 1 is normally connected to a personal computer or the like, and the application is running on the personal computer. Because the display device of Patent Document 1 enters the normal operation mode when a user operates the application by touching the display screen, the power consumption cannot be reduced.

The present invention was devised in consideration of the problem described above, and is aiming mainly at providing a display device that can lower the backlight power consumption even during the display screen is touched by a user.

### Means for Solving the Problems

In order to solve the problem described above, a display device of the present invention includes: a display panel with built-in light sensors detecting an incoming light intensity distribution; a location detection element determining a location of a touch by an object on front surface of the display panel based on the light intensity distribution detected by the light sensors; a backlight that can project light individually to a plurality of regions constituting a panel surface of the display panel from behind the panel; and a light emission control element controlling the backlight such that a prescribed amount of light is projected to a particular region of the plurality of regions, and that an amount of light which is smaller than the prescribed amount is projected to a remaining region other than the particular region of the plurality of regions.

According to the configuration described above, the display device can project an amount of light, which is smaller than the prescribed light amount, to regions of the panel surface where the location of a touching object does not need to be determined.

As a result, even when a user is touching the display screen, the backlight power consumption can be reduced below the conventional backlight power consumption level.

In order to solve the problem described above, a display method according to the present invention, where the display involved includes a backlight that can project light individually to a plurality of regions constituting the panel surface of the display panel with built-in sensors from behind the panel, which built-in sensors detect the incoming light intensity distribution, includes a light-emitting control process in which the backlight is instructed to project light to the display panel. In the light-emitting control process, light of a specified amount is projected to a particular region of the plurality of regions, and a smaller amount of light than the predetermined amount is projected to a remaining region other than the particular region of the plurality of regions.

According to the configuration described above, a display method of the present invention provides the same operational effect as a display device of the present invention.

### Effects of the Invention

As described above, a display device of the present invention provides an effect that the backlight power consumption can be reduced even when a user is touching the display screen.

### BRIEF DESCRIPTION OF THE DRAWINGS

FIG. 1 is a block diagram showing the configuration of the main part of a display device according to an embodiment of the present invention.

FIG. 2 is a block diagram showing in detail the configuration of the display panel of a display device according to an embodiment of the present invention.

FIG. 3 is a flowchart showing the operation of a display device according to an embodiment of the present invention.

FIG. 4 is a cross-sectional view schematically showing a liquid crystal panel with built-in sensors included in a display device according to an embodiment of the present invention.

FIG. 5 schematically illustrates the manner in which a liquid crystal display panel with built-in sensors included in a display device according to an embodiment of the present invention determines the location of a touch by a user through the detection of a reflection image.

FIG. 6 schematically shows the arrangement of the backlight and the liquid crystal display with built-in sensors of a display device according to an embodiment of the present invention.

FIG. 7 is a graph according to an embodiment of the present invention, showing changes in the intensity of the infrared light projected from the IR backlight along the up/down direction of the liquid crystal panel.

FIG. 8 is a graph according to an embodiment of the present invention, showing sensing data values analyzed by the detected information analyzing unit, which data is obtained along the up/down direction line including the location in a scanned image touched by a finger or a pen. Graph (a) shows the case when the recognition area control circuit did not control the current, and graph (b) shows the case when the recognition area control circuit controlled the current.

FIG. 9 shows the positional relation between the display area and the operation area for the application run on the host computer, and the IR backlight turned on and off by the display device according to an embodiment of the present invention.

FIG. 10 shows in detail the configuration of the IR backlight included in a display device according to an embodiment of the present invention.

FIG. 11 is a timing chart of a display device according to an embodiment of the present invention.

FIG. 12 is another timing chart of a display device according to an embodiment of the present invention.

FIG. 13 is yet another timing chart of a display device according to an embodiment of the present invention.

FIG. 14 shows a user interface including the display area and the operation area for the application run on the host computer.

FIG. 15 is a block diagram showing the configuration of a main section of a display device according to an embodiment of the present invention.

FIG. 16 is a cross-sectional view schematically showing the liquid crystal panel with built-in sensors included in a display device according to an embodiment of the present invention.

### DETAILED DESCRIPTION OF EMBODIMENTS

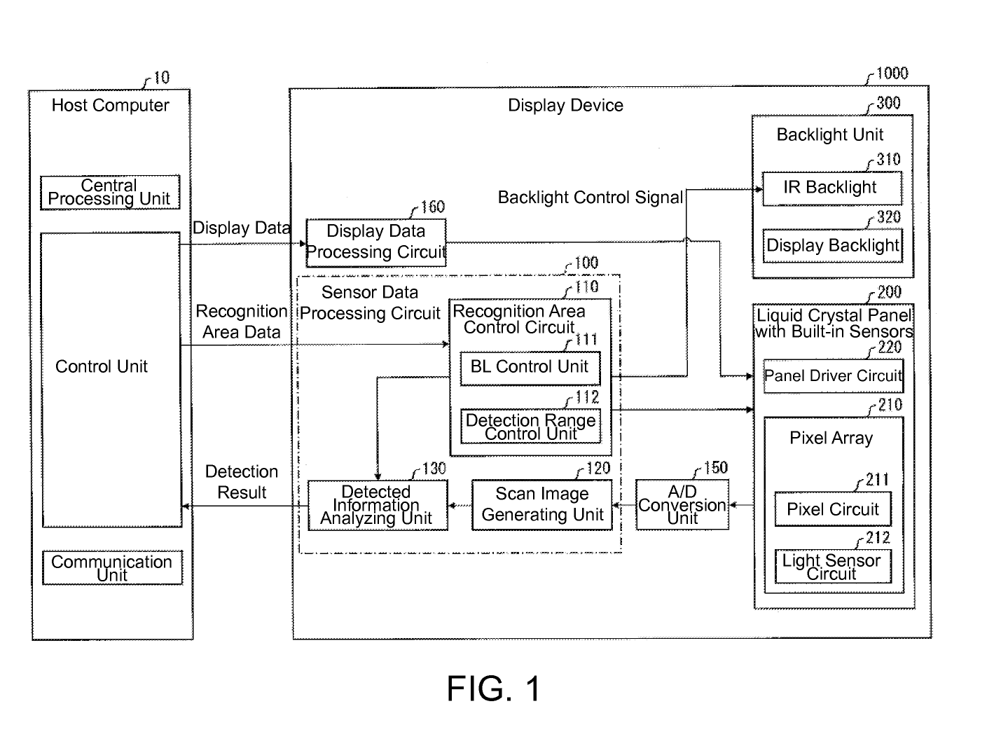

A display device of the present embodiment is described with reference to FIG. 1 to FIG. 13.

First, the configuration of a display device of the present embodiment is described with reference to FIG. 1 and FIG. 6. FIG. 1 is a block diagram showing the configuration of the main section of the display device. FIG. 6 schematically shows the arrangement of the backlight and the liquid crystal panel with built-in sensors.

Configuration of Display Device 1000

As shown in FIG. 1, a display device 1000 includes a sensor data processing circuit 100, an A/D conversion unit 150, a display data processing circuit 160, a liquid crystal panel with built-in sensors 200, and a backlight unit 300.

The backlight unit 300 includes a display backlight 320 for image display on the liquid crystal panel with built-in sensors 200, and an IR backlight 310 for object image detection. As shown in FIG. 6, the IR backlight 310 has a light source 312a over the liquid crystal panel with built-in sensors 200, and a light source 312b under the liquid crystal panel with built-in sensors 200. When the light source 312a is ON, it emits infrared light to the upper half portion of the display surface of the liquid crystal panel with built-in sensors 200, and when the light source 312b is ON, it emits infrared light to the lower half portion of the display surface of the liquid crystal panel with built-in sensors 200. As described below, the display device 1000 can conduct the object image detection in a region of the liquid crystal panel with built-in sensors 200 where the infrared light is projected.

The sensor data processing circuit 100 receives the recognition area data, which is described below, as an input from the host computer 10, and determines ON/OFF status of the light source 312a and the light source 312b based on the recognition area data. The sensor data processing circuit 100 also generates a scan image based on the digital data sent from the A/D conversion unit 150, and detects the location at which an object such as a pen or a finger approaches or touches the liquid crystal panel with built-in sensors 200 based on the scan image data, and outputs the detection result to the host computer 10.

The display data processing circuit 160 conducts the color correction processing and the frame rate conversion processing as necessary on the display data inputted from outside, and outputs the processed display data to the liquid crystal panel with built-in sensors 200.

The liquid crystal panel with built-in sensors 200 can perform object image detection as well as display of the display data.

The A/D conversion unit 150 converts the analog sensor output signal outputted from the liquid crystal panel with built-in sensors 200 into a digital signal, and outputs this digital signal to the sensor data processing circuit 100.

The liquid crystal panel with built-in sensors 200 is described more in detail below.

Brief Description of Liquid Crystal Panel with Built-in Sensors 200

The liquid crystal panel with built-in sensors 200 displays the display data when the panel driver circuit 220 applies a voltage on an image circuit 211 of a pixel array 210.

Also, as described above, the liquid crystal panel with built-in sensors 200 can perform object image detection as well as display of the display data. Here, object image detection means, for example, the determination of the location at which a user points (touches) by a finger, a pen, or the like, or reading (scanning) of images such as printed matters. The device used for the display is not limited to a liquid crystal panel. It may be an organic EL (Electro Luminescence) panel or the like.

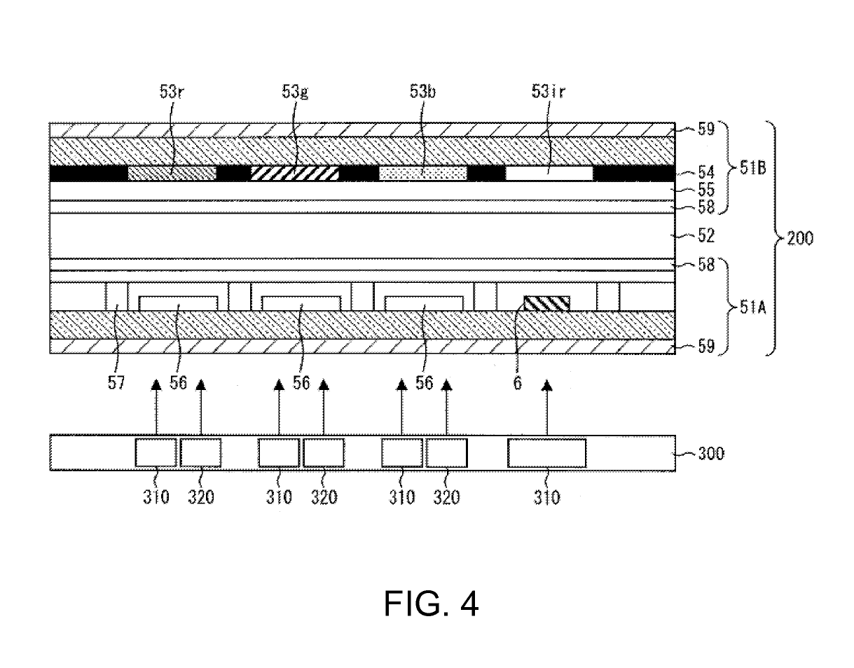

The configuration of the liquid crystal panel with built-in sensors 200 is described with reference to FIG. 4. FIG. 4 is a cross-sectional view schematically showing the liquid crystal panel with built-in sensors 200. The liquid crystal panel with built-in sensors 200 described here is merely an example. The liquid crystal panel with built-in sensors may have any configuration as long as the display also functions as a screen for reading.

As shown in the figure, the liquid crystal panel with built-in sensors 200 includes an active matrix substrate 51A disposed on the backside, an opposite substrate 51B disposed on the front side, and a liquid crystal layer 52 sandwiched between the two substrates. The active matrix substrate 51A has pixel electrodes 56 constituting a pixel circuit 211 (not shown), a data signal line 57, a light sensor circuit 212 (not shown), an alignment film 58, a polarizing plate 59, and the like. The opposite substrate 51B includes color filters 53r (red), 53g (green), and 53b (blue), an IR transmitting filter 53ir, a light shielding film 54, an opposite electrode 55, an alignment film 58, a polarizing plate 59, and the like. Also, a backlight unit 300 is disposed on the backside of the liquid crystal panel with built-in sensors 200. Also, as shown in the figure, the light projected from the IR backlight 310 passes through the color filters 53r, 53g, and 53b, and the IR transmitting filter 53ir, and the light projected from the display backlight 320 passes through the color filters 53r, 53g, and 53b.

The photodiode 6 included in the light sensor circuit 212 is disposed near the pixel electrode 56 provided with the color filter 53b.

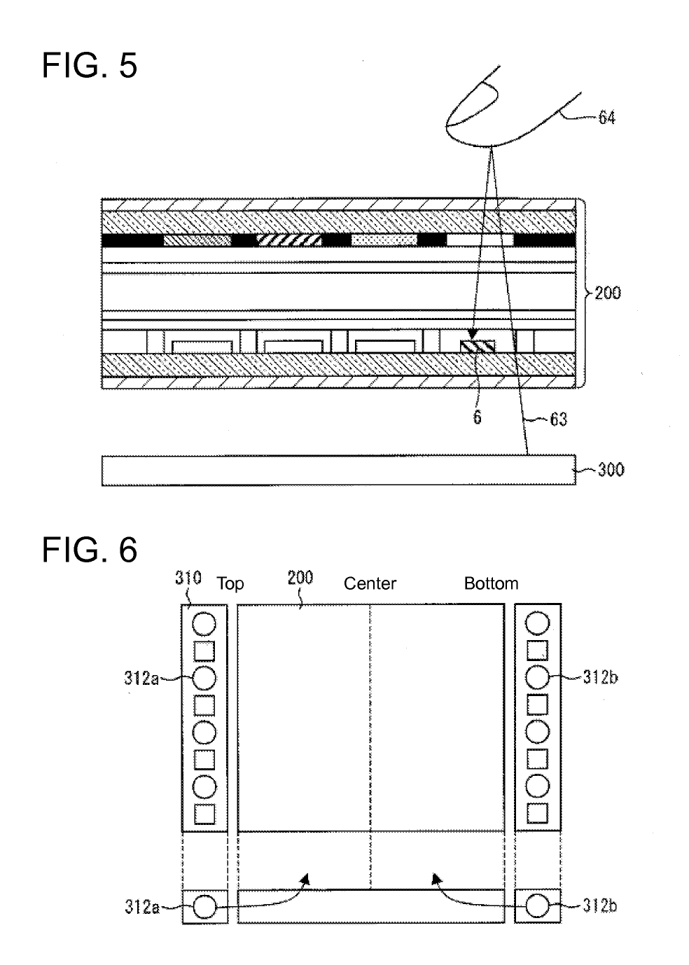

Next, two methods for determining the location on the liquid crystal panel with built-in sensors 200 touched by a user using a finger or a pen is described with reference to FIG. 5.

FIG. 5 schematically shows the manner in which the location touched by a user is determined through the reflected image detection. When light 63 is emitted from the IR backlight 310, the light sensor circuit 212 including the photodiode 6 detects the light 63 reflected by an object 64 such as a finger. Thus, the reflection image of the object 64 can be detected. This way, the liquid crystal panel with built-in sensors 200 can determine the location of a touch by detecting the reflection image.

Configuration of Liquid Crystal Panel with Built-in Sensors 200

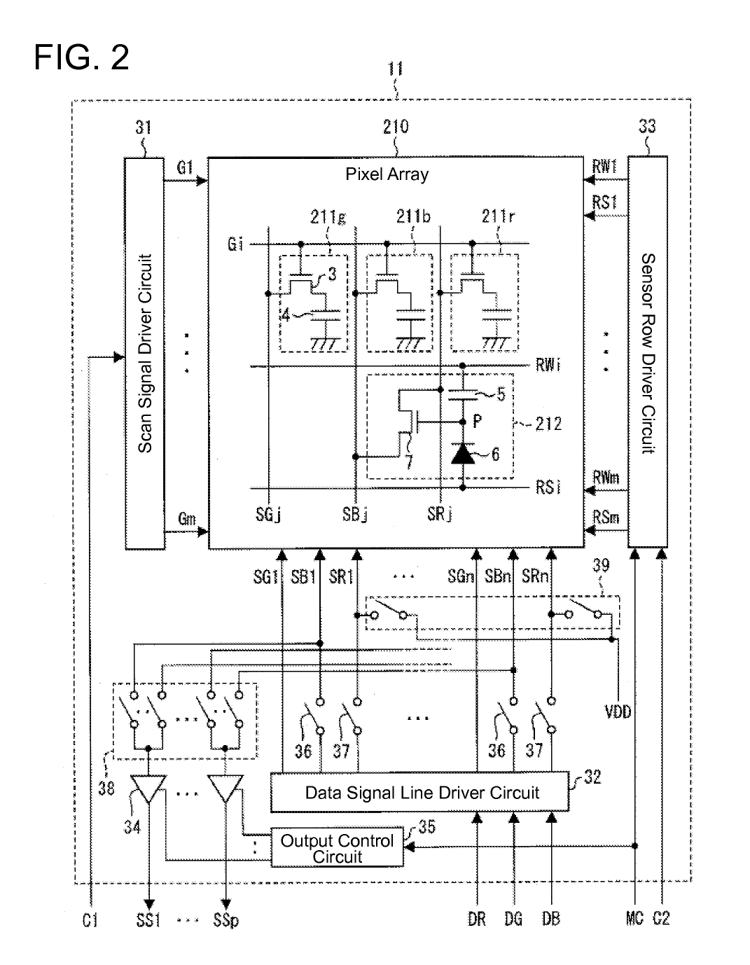

Next, the configuration of a liquid crystal panel with built-in sensors 200 is described with reference to FIG. 2.

FIG. 2 is a block diagram showing in detail the configuration of the liquid crystal panel with built-in sensors 200. As shown in FIG. 2, the pixel array 210 includes m scan signal lines G1 to Gm, 3n data signal lines SR1 to SRn, SG1 to SGn, and SB1 to SBn, and (m×3n) pixel circuits 211. The pixel array 210 also includes (m×n) light sensor circuits 212, m sensor read-out lines RW1 to RWm, and m sensor reset lines RS1 to RSm.

The scan signal lines G1 to Gm are disposed in parallel with one another. The data signal lines SR1 to SRn, SG1 to SGn, and SB1 to SBn are disposed in parallel with each other and are arranged perpendicular to the scan signal lines G1 to Gm. The sensor read-out lines RW1 to RWm and the sensor reset lines RS1 to RSm are disposed in parallel with the scan signal lines G1 to Gm.

A pixel circuit 211 is provided in the vicinity of each of the intersections of the scan signal lines G1 to Gm and the data signal lines SR1 to SRn, SG1 to SGn, and SB1 to SBn. The pixel circuits 211 are arranged two-dimensionally overall, with m circuits arranged in the column direction (vertical direction in FIG. 2), and 3n circuits arranged in the row direction (horizontal direction in FIG. 2). Based on the color of the color filter provided, the pixel circuits 211 are categorized into R pixel circuit 211r, G pixel circuit 211g, and B pixel circuit 211b. These three kinds of pixel circuits are arranged in the row direction in the order of G, B, and R, and three pixel circuits, one of each kind, constitute a pixel.

The pixel circuit 211 includes a TFT (Thin Film Transistor) 3 and a liquid crystal capacitance 4. The gate terminal of TFT 3 is connected to the scan signal line G1 (i is an integer of at least 1 and no greater than m), the source terminal is connected to one of the data signal lines SRj, SGj, or SBj (j is an integer of at least 1 and no greater than n), and the drain terminal is connected to one of the electrodes of the liquid crystal capacitance 4. To the other electrode of the liquid crystal capacitance 4, a common electrode voltage is applied. The data signal lines SR1 to SRn connected to the R pixel circuits 211r are hereinafter referred to as R data signal lines, and the data signal lines SB1 to SBn connected to the B pixel circuits 211b are hereinafter referred to as B data signal lines. The pixel circuit 211 may include an auxiliary capacitance.

The light transmission of the pixel circuit 211 (sub-pixel luminance) is determined by the voltage applied on the pixel circuit 211. To apply a voltage V on the pixel circuit 211 connected to the scan signal line G1 and the data signal line SXj (X is R, G, or B), a HIGH level voltage (voltage that turns TFT 30N) is applied to the scan signal line G1, and a voltage V is applied to the data signal line SXj. The sub-pixel luminance can be set to a desired level by applying a voltage representing the display data on the pixel circuit 211.

The light sensor circuit 212 includes a capacitor 5, a photodiode 6, and a sensor preamplifier 7. In the present embodiment, one light sensor circuit 212 is provided for each pixel, but the present invention is not limited to such. One light sensor circuit 212 may be provided for a plurality of pixels. One of the electrodes of the capacitor 5 is connected to the cathode terminal of the photodiode 6 (hereinafter this connection point is referred to as contact P). The other electrode of the capacitor 5 is connected to the sensor read-out line RWi, and the anode terminal of the photodiode 6 is connected to the sensor reset line RSi. The sensor preamplifier 7 is constituted of a TFT composed of a gate terminal connected to the contact P, a drain terminal connected to the R data signal line SRj, and a source terminal connected to the B data signal line SBj.

For light amount detection at the light sensor circuit 212 connected to the sensor read-out line RWi, the B data signal line SBj, and the like, prescribed voltages are applied to the sensor read-out line RWi and the sensor reset line RSi, and a power supply voltage VDD is applied on the R data signal line SRj. When the infrared light enters the photodiode 6 after the prescribed voltages are applied to the sensor read-out line RWi and the sensor reset line RSi, the current corresponding to the amount of the light entered is supplied to the photodiode 6, and the voltage at contact P lowers by the amount corresponding to the current that flowed. With this timing, a high voltage is applied on the sensor read-out line RWi to raise the voltage at the contact P and to raise the gate voltage of the sensor preamplifier 7 to or beyond the threshold value. The power supply voltage VDD is then applied on the R data signal line SRj. This causes the voltage at contact P to be amplified by the sensor preamplifier 7, and the amplified voltage is outputted to the B data signal line SBj. As a result, the amount of the light detected by the light sensor circuit 212 can be obtained based on the voltage at the B data signal line SBj.

In the vicinity of the pixel array 210, a scan signal line driver circuit 31, a data signal line driver circuit 32, a sensor row driver circuit 33, p (p is an integer of at least 1 and no greater than n) sensor output amplifier(s) 34, an output control circuit 35, and a plurality of switches 36 to 39 are disposed. These circuits correspond to the panel driver circuit 220 of FIG. 1.

The data signal line driver circuit 32 has 3n output terminals for 3n data signal lines. A switch 36 is provided between each of the B data signal lines SB1 to SBn and the corresponding one of the n output terminals, and a switch 37 is provided between each of the R data signal lines SR1 to SRn and the corresponding one of the n output terminals. B data signal lines SB1 to SBn are divided into groups each composed of p lines. One switch 38 is provided between the kth (k is an integer of at least 1 and no greater than p) B data signal line in each of the groups and the input terminal of the kth sensor output amplifier 34. A switch 39 is provided between each of the R data signal lines SR1 to SRn and the power supply voltage VDD. In FIG. 2, there are n each of switches 36 to 39.

The display device 1000 divides a frame period into a display period during which the signal (voltage signal representing the display data) is written to the pixel circuit and a sensing period during which the signal (electrical signal representing the amount of the light received) is retrieved from the light sensor circuit 212. The circuit shown in FIG. 2 operates differently during the display period and the sensing period. During the display period, switches 36 and 37 are ON, and switches 38 and 39 are OFF. On the other hand, during the sensing period, switches 36 and 37 are OFF and switches 38 and 39 are ON, and switches 38 turns ON in a time division manner so that the B data signal lines SB1 to SBn in each group are sequentially connected to the input terminals of the sensor output amplifiers 34.

During the display period, the scan signal line driver circuit 31 and the data signal line driver circuit 32 operate. The scan signal line driver circuit 31 selects one of the scan signal lines G1 to Gm every line time following the timing control signal C1. A HIGH level voltage is applied on the selected scan signal lines, and a low-level voltage is applied on the rest of the scan signal lines. The data signal line driver circuit 32 drives the data signal lines SR1 to SRn, SG1 to SGn, and SB1 to SBn in a longitudinal sequential manner based on the display data DR, DG, and DB outputted from the display data processing circuit 160. More specifically, the data signal line driver circuit 32 stores at least one row of display data DR, DG, and DB at a time, and every one line time, applies voltages corresponding to the one row of the display data to the data signal lines SR1 to SRn, SG1 to SGn, and SB1 to SBn. The data signal line driver circuit 32 may also drive the data signal lines SR1 to SRn, SG1 to SGn, and SB1 to SBn in a dot sequential manner.

During the sensing period, the sensor row driver circuit 33, the sensor output amplifier 34, and the output control circuit 35 operate. The sensor row driver circuit 33 selects one signal line from the sensor read-out lines RW1 to RWm and one signal line from the sensor reset lines RS1 to RSm every line time following the timing control signal C2. Prescribed read-out voltage and the reset voltage are applied on the selected data read-out lines and the selected sensor reset lines. Voltages that are different from those applied when selected are applied on other signal lines. Typically, the duration of one line time differs between the display period and the sensing period. The sensor output amplifier 34 amplifies the voltage selected by the switch 38, and outputs the voltage as sensor output signals SS1 to SSp. Operation of the output control circuit 35 is described below.

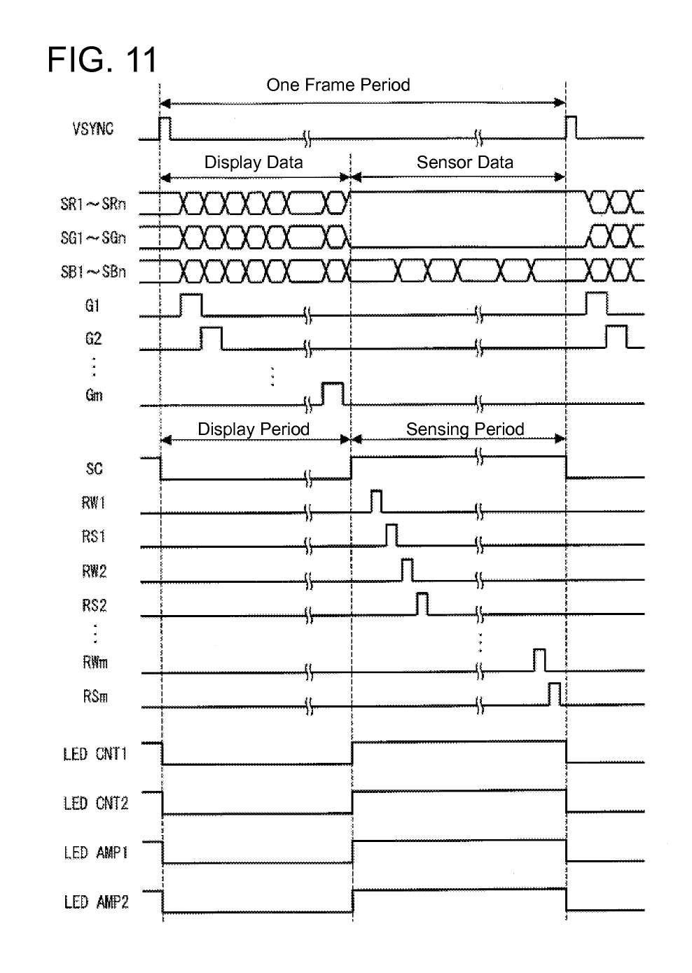

FIG. 11 is a timing chart of the display device 1000. As shown in FIG. 11, vertical synchronization signal VSYNC becomes HIGH level every one frame period, and one frame period is divided into a display period and a sensing period. A sense signal SC indicates either the display period or the sensing period. The sense signal SC becomes LOW level during the display period, and becomes HIGH level during the sensing period.

During the display period, switches 36 and 37 turn ON, and the data signal lines SR1 to SRn, SG1 to SGn, and SB1 to SBn are connected to the data signal line driver circuit 32. During the display period, first, the voltage of the scan signal line G1 becomes HIGH level. Next, the voltage of the scan signal line G2 becomes HIGH level. Then, voltages of the scan signal lines G3 to Gm become HIGH level successively one by one. While the voltage of the scan signal line G1 is at HIGH level, for the data signal lines SR1 to SRn, SG1 to SGn, and SB1 to SBn, voltages are applied on 3n pixel circuits 211 connected to the scan signal line G1.

During the sensing period, switch 39 turns ON, and switch 38 turns ON in a time division manner. As a result, the power supply voltage VDD is fixedly applied on R data signal lines SR1 to SRn, and B data signal lines SB1 to SBn are connected to the input terminals of the sensor output amplifiers 34 in a time division manner. During the sensing period, first, the sensor read-out line RW1 and the sensor reset line RS1 are selected. Next, the sensor read-out line RW2 and the sensor reset line RS2 are selected. Then, one of the sensor read-out lines RW3 to RWm and one of the sensor reset lines RS3 to RSm are selected, successively one pair at a time. The read-out voltage and the reset voltage are applied on the data read-out line and the sensor reset line. While the sensor read-out line RWi and the sensor reset line RSi are selected, voltages corresponding to the amount of the light detected by n light sensor circuits 212B connected to the sensor read-out line RWi are outputted to data signal lines SB1 to SBn. As described below, when the object image detection region is not the entire surface of the liquid crystal panel with built-in sensors 200, of sensor read-out lines RW1 to RWm and sensor reset lines RS1 to RS, only the sensor read-out lines and the sensor reset lines connected to the light sensor circuits 212 provided in pixels within the object image detection region are selected successively one pair at a time.

Sensor Data Processing Circuit 100

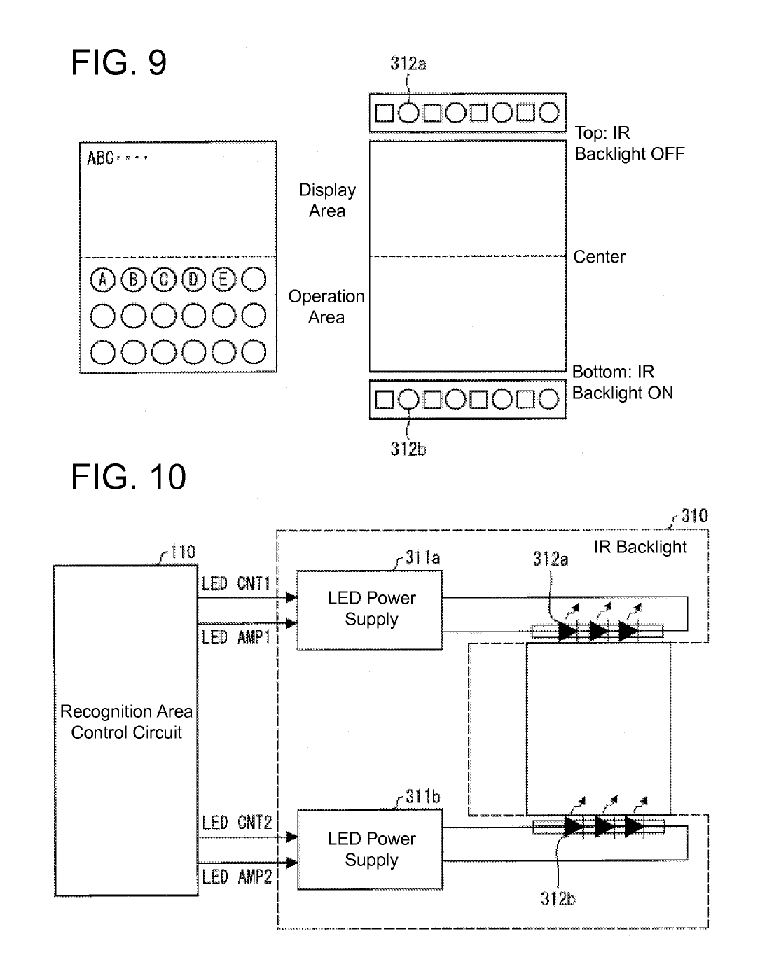

The sensor data processing circuit 100 is described with reference to FIG. 9 to FIG. 13, but here, the operation of the host computer 10 is briefly described first.

When an application is running on the host computer 10 and UI is displayed, the host computer 10, following the instruction of the application, outputs to the display device 1000 the recognition area data that turns OFF the light source that emits infrared light to the display area and turns ON the light source that emits infrared light to the operation area. For example, when an application displaying an UI as shown at left in FIG. 9 is running on the host computer 10, the host computer 10 outputs to the display device 1000 the recognition area data that turns the light source 312a OFF and turns the light source 312b ON as shown at right in FIG. 9. The sensor data processing circuit 100 is described below.

The sensor data processing circuit 100 includes a recognition area control circuit 110, a scan image generating unit 120, and a detected information analyzing unit 130. The recognition area control circuit 110 also includes a BL control unit 111 and a detection range control unit 112.

When the recognition area control circuit 110 receives the recognition area data from the host computer 10, the BL control unit 111 controls the ON/OFF state of the light sources 312a and 312b of the IR backlight 310 based on the value of the recognition area data (hereinafter this operation is referred to as “backlight control”). Here, the recognition area data is a two-bit data, with the first bit “1” and “0” respectively indicate ON and OFF state of the light source 312b. Likewise, the second bit “1” and “0” respectively indicate ON and OFF state of the light source 312a.

The backlight control operation of the BL control unit 111 is described more in detail with reference to FIG. 10. FIG. 10 shows the configuration of the IR backlight 310 in detail.

As shown in FIG. 10, the IR backlight 310 includes an LED power supply 311a that supplies power to the light source 312a, and an LED power supply 311b that supplies power to the light source 312b.

The BL control unit 111 supplies LED CNT1, which is a signal that controls the ON/OFF state of the light source 312a, and supplies LED AMP1, which is a signal that controls the amount of light generated by the light source 312a when the light source 312a is ON, to the LED power supply 311a. Similarly, the BL control unit 111 supplies LED CNT2, which is a signal that controls the ON/OFF state of the light source 312b, and supplies LED AMP2, which is a signal that controls the amount of light generated by the light source 312b when the light source 312b is ON, to the LED power supply 311b.

The LED drive timing of the display device 1000 is described below with reference to FIG. 11 to FIG. 13, using examples when the recognition area data that the recognition area control circuit 110 receives from the host computer 10 is “11”, and when it is “01”.

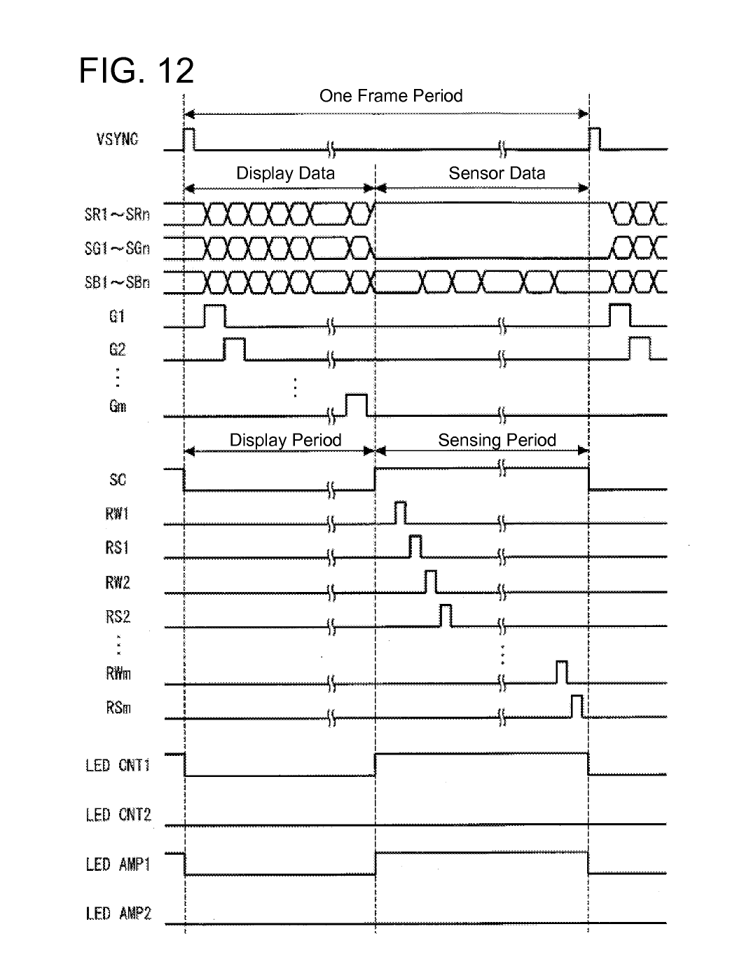

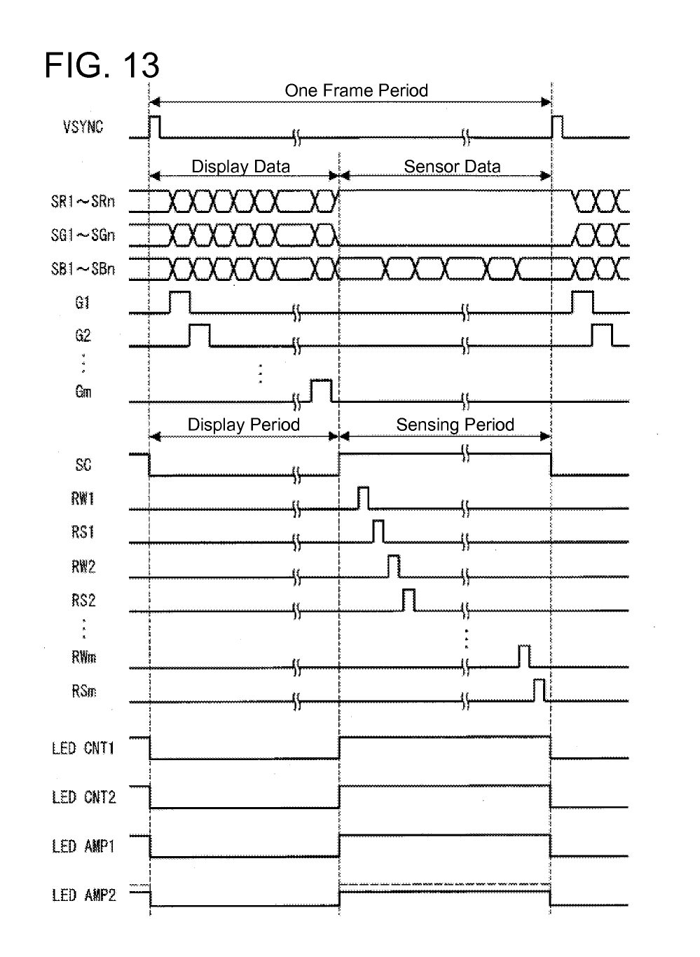

FIG. 11 is a timing chart of the display device 1000 when the recognition area data “11” is received, and FIG. 12 and FIG. 13 are example timing charts of the display device 1000 when the recognition area data “01” is received.

As shown in FIG. 11 to FIG. 13, regardless of the recognition area data value received by the recognition area control circuit 110, the BL control unit 111 sets LED CNT1, LED AMP1, LED CNT2, and LED AMP2 to 0 during the display data period.

On the other hand, as shown in FIG. 11, when the recognition area control circuit 110 receives a recognition area data of “11” during the sensing period, the BL control unit 111 sets LED CNT1 and LED CNT2 to 1, and sets LED AMP1 and LED AMP2 to a predetermined amplitude value.

Also, as shown in FIG. 12, when the recognition area control circuit 110 receives a recognition area data of “01” during the sensing period, the BL control unit 111 sets LED CNT1 to 1, sets LED CNT2 to 0, sets LED AMP1 to a predetermined amplitude value, and sets LED AMP2 to 0. That is, because only the light source 312a is turned ON, object image detection is conducted only on the upper half region of the liquid crystal panel with built-in sensors 200, and the power consumption is reduced accordingly.

When the recognition area control circuit 110 receives the recognition area data “01”, as shown in FIG. 13, BL control unit 111 may supply the same signals as in FIG. 12 to IR backlight 310 for LED CNT1, LED CNT, and LED AMP1, and may set LED AMP2 to a value below the predetermined amplitude value. That is, instead of turning the light source 312b OFF, the amount of the light emitted from the light source 312b is reduced to below the predetermined amount. In this case, depending on the amount of the light emitted by the light source 312b, object image detection is conducted also on the lower half portion of the liquid crystal panel with built-in sensors 200, although the accuracy of the object image detection may be lowered. However, because the amount of the light emitted from the light source 312b is reduced below the predetermined value, power consumption is reduced accordingly.

When the liquid crystal panel with built-in sensors 200 conducts the image detection using a portion of the liquid crystal panel, the amount of the light emitted from the light source emitting the infrared light to the region where the image detection is conducted may be greater than the above-mentioned predetermined value. For example, when the recognition area control circuit 110 receives the recognition data “01” (when only the upper half region of the liquid crystal panel with built-in sensors 200 is used for image detection), the BL control unit 111 may set LED AMP1 to a value greater than the above-mentioned predetermined amplitude value (this operation is hereinafter referred to as “current control”). However, in this case, the current control needs to be conducted such that the power consumption of the entire IR backlight 310 becomes smaller than the power consumption when the predetermined amount of the light is emitted from the light source 312a and the light source 312b.

Although not illustrated in figures, the power consumption of the IR backlight 310 may be reduced in the following manner.

That is, when the recognition area control circuit 110 receives the recognition area data “01”, instead of holding LED CNT2 to 1 throughout the sensing period, LED CNT2 may be set to 1 only for a part of the sensing period after the display period is switched to the sensing period. Also, LED CNT2 may be set to 1 less frequently than LED CNT1. For example, the cycle at which LED CNT2 is set to 1 may be longer than the cycle at which LED CNT1 is set to 1. That is, instead of setting LED CNT2 to 1 every time the display period is switched to the sensing period, out of n (n>1) sensing periods, LED CNT2 may be set to 1 only during m sensing periods (m is at least 1 and not greater than n).

As described above, the BL control unit 111 not only conducts the object image detection using the entire surface of the liquid crystal panel with built-in sensors 200, or not conduct the object image detection at all, but also limits the region of the liquid crystal panel with built-in sensors 200 to be used for the object image detection to “upper half” or “lower half” portion. This way, power consumption of the IR backlight 310 can be reduced. Also, the BL control unit 111 not only controls such that the “upper half” or “lower half” of the liquid crystal panel with built-in sensors 200 is not used for the object image detection at all, but also can reduce the power consumption of the IR backlight 310 by lowering the accuracy of the object image detection.

Meanwhile, the detection range control unit 112 controls the panel driver circuit 220 such that the light amount is detected by the light sensor circuits 212 provided in individual pixels in the region used for the object image detection, or such that the light amount will not be detected by the light sensor circuits 212 provided in individual pixels in the region used for the image detection (hereinafter this operation is referred to as “sensor control”).

Backlight control operation and sensor control operation of the sensor data processing circuit 100 are described above. Next, the operation of the sensor data processing circuit 100 for outputting the detection result of the image detection to the host computer 10 is described. But before that, the operation of the liquid crystal panel with built-in sensors 200 in response to the recognition area data values received by the display device 1000 from the host computer 10 is described.

The operation of the liquid crystal panel with built-in sensors 200 during the display period does not depend on the recognition area data values. On the other hand, in this embodiment, the operation of the liquid crystal panel with built-in sensors 200 during the sensing period differs depending on the recognition area data values.

For example, when the recognition area data is “01” (when only upper half of the liquid crystal panel with built-in sensors 200 is used for the object image detection), during the sensing period, the panel driver circuit 220 selects, out of sensor read-out lines RW1 to RWm and sensor reset lines RS1 to RSm, only the sensor read-out lines and the sensor reset lines connected to some of the light sensor circuits 212 (the light sensor circuits 212 provided in individual pixels within the upper half of the liquid crystal panel with built-in sensors 200). At this time, the output control circuit 35 instructs that sensor output signals SS1 to SSp are outputted only from the some of the sensor output amplifiers 34. Also, the A/D conversion unit 150 converts the analog signals retrieved from the above-mentioned some of the light sensor circuits into digital signals and outputs the digital signals to the sensor data processing circuit 100.

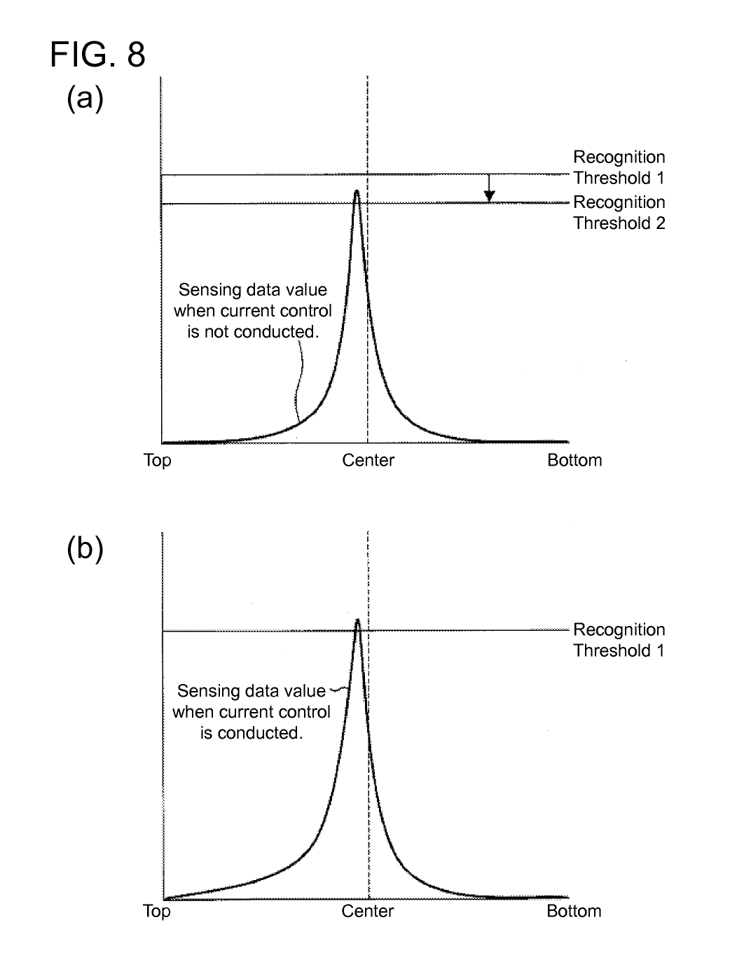

The operation of the sensor data processing circuit 100 for outputting the detection result of the image detection to the host computer 10 is described below with reference to FIG. 8. FIG. 8 is a graph showing the sensing data values obtained along the up/down direction of the scan image, including the data at the location of a touch by a finger, a pen, or the like. Here, FIG. 8(a) is a graph when the recognition area control circuit 110 did not conduct the current control, and FIG. 8(b) is a graph when the recognition area control circuit 110 conducted the current control.

The scan image generating unit 120 generates a scan image from the digital signals received from the A/D conversion unit 150. Here, when the photodiode 6 does not detect any external light, the pixel values of the portion of the scan image corresponding to an object become high, and the pixel values of the portion not corresponding to the object become low.

The detected information analyzing unit 130 analyzes the scan image data (sensing data) generated by the scan image generating unit 120. The scan image data is analyzed differently between when the recognition area control circuit 110 conducts the current control and when the circuit does not conduct the current control.

First, the case when the recognition area control circuit 110 does not conduct the current control is described.

In this embodiment, when the current control is not conducted, the detected information analyzing unit 130 receives a threshold data (recognition threshold 2 (second threshold) in FIG. 8(a)) from the recognition area control circuit 110. This threshold data is smaller than the predetermined threshold (recognition threshold 1 (first threshold) in FIG. 8(a)). The detected information analyzing unit 130 extracts a pair of coordinates at which the pixel value of the sensing data is at least as high as the recognition threshold 2 (if there are more than one pair of such coordinates, a representative pair of the coordinates is extracted). Then, the detected information analyzing unit 130 outputs the extracted coordinates to the host computer 10. Switching the threshold for extracting coordinates from the predetermined threshold (recognition threshold 1) to the recognition threshold 2 is hereinafter referred to as “recognition threshold adjustment.”

On the other hand, when the recognition area control circuit 110 conducts the current control, the detected information analyzing unit 130 extracts a pair of coordinates at which the pixel value of the sensing data is at least as high as the recognition threshold 1 (if there are more than one pair of such coordinates, a representative pair of the coordinates is extracted). Then, the detected information analyzing unit 130 outputs the extracted coordinates to the host computer 10.

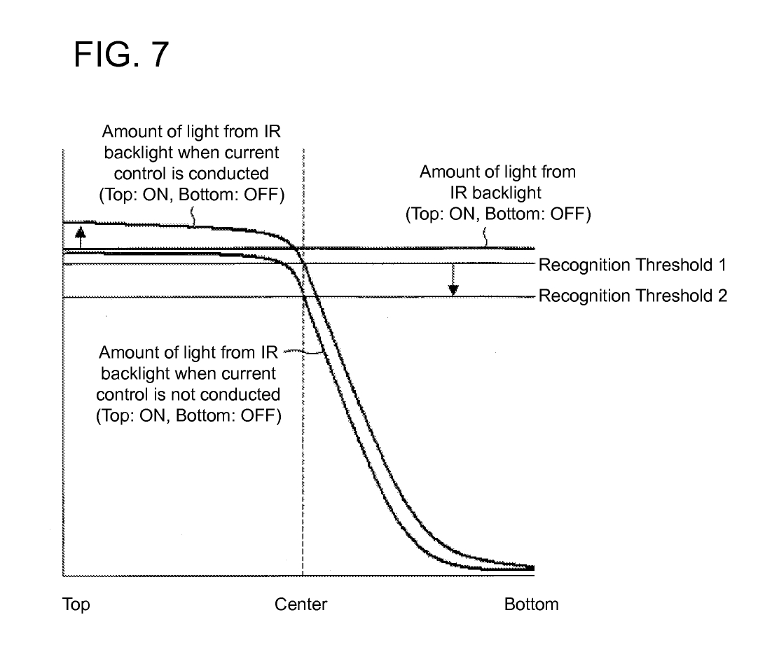

The recognition area control circuit 110 operates as described above. Here, the benefits of the current control and the recognition threshold adjustment discussed in the description are explained briefly below with reference to FIG. 7, FIG. 8(a), and FIG. 8(b).

Benefits of the Current Control and the Recognition Threshold Adjustment

As described above, in the backlight unit 300, the light source 312a projects the infrared light to the upper half of the liquid crystal panel with built-in sensors 200, and the light source 312b projects the infrared light to the lower half of the liquid crystal panel with built-in sensors 200. However, in reality, part of the infrared light emitted from the light source 312a lands on the lower half of the liquid crystal panel with built-in sensors 200, and part of the infrared light emitted from the light source 312b lands on the upper half of the liquid crystal panel with built-in sensors 200. Such infrared light is herein referred to as “leaked light.”

Here, the influence of the leaked light is described using an example of the case when the recognition area control circuit 110 received the recognition area data “01”. As described above, in this case, because only the light source 312a projects the infrared light, only the upper half of the liquid crystal panel with built-in sensors 200 is irradiated with the infrared light. However, as shown in FIG. 7, compared to the case that the recognition area data “11” is received, a smaller amount of the infrared light is projected on the upper half of the liquid crystal panel with built-in sensors 200, because there is no leaked light from the light source 312b. With less projected light, the intensity of the light reflected by an object such as a finger is also reduced. The pixel value of the object in the scan image, therefore, declines (i.e., less accuracy in the object image detection). Therefore, as shown in FIG. 8(a), when the predetermined threshold (recognition threshold 1) is used as the recognition threshold, the coordinates specified by an object is possibly not extracted.

The recognition threshold adjustment is an effective way to solve this problem. That is, as shown in FIG. 8(a), by lowering the recognition threshold from the recognition threshold 1 to the recognition threshold 2, the coordinates specified by an object can more reliably be extracted. Alternatively, the current control may be conducted. By conducting the current control, the influence of the absence of leaked light from the light source 312b can be offset, and therefore the coordinates specified by an object can more reliably be extracted.

As described above, although the current control and the recognition threshold adjustment provide a benefit that the coordinates specified by an object can more reliably be extracted, according to the present invention, the current control and recognition threshold adjustment are not necessarily required to achieve the objective of the invention.

Overall Operation of Display Device 1000

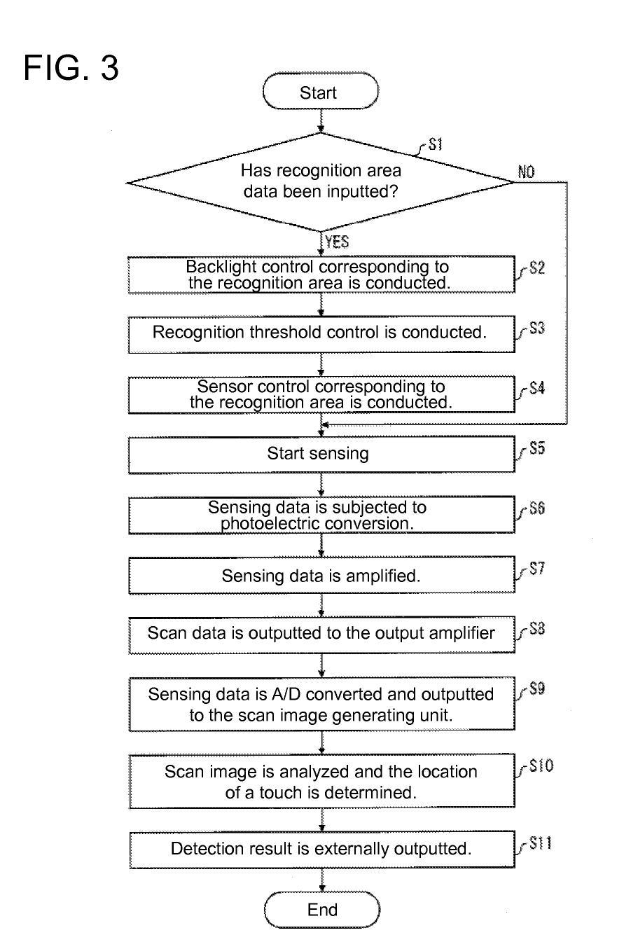

Operations and the like of individual blocks constituting the display device 1000 are described above in detail, but the overall operation flow of the display device 1000 is described below with reference to FIG. 3. It should be noted that operations of the display device 1000 described here are the operation when the recognition threshold adjustment is conducted, but the current control is not conducted. Also, it should be noted that description of the image display operation is omitted.

FIG. 3 is a flowchart describing the operation of the display device 1000 in which the coordinates specified by an object is outputted to the host computer 10.

As shown in FIG. 3, the recognition area control circuit 110 determines whether the recognition area data has been received from the host computer 10 (S1). If the determination is “NO,” the process proceeds to S5.

On the other hand, if it is determined that the recognition area data has been received (“YES” at S1), the BL control unit 111 of the recognition area control circuit 110 performs the backlight control according to the recognition area (S2). The recognition area control circuit 110 also controls the recognition threshold. Specifically, the recognition area control circuit 110 outputs the threshold data (recognition threshold 2) to the detected information analyzing unit 130 (S3). The detection range control unit 112 performs the sensor control according to the recognition area (S4). Then, the process proceeds to S5.

In S5, the panel driver circuit 220 starts sensing. That is, the panel driver circuit 220 selects a sensor read-out line and a sensor reset line, one pair of lines at a time, both of the lines being connected to the light sensor circuit 212 provided for each individual pixel in the region used for the object image detection. The panel driver circuit 220 then applies a prescribed read-out voltage and a reset voltage to the selected sensor read-out line and the selected sensor reset line, respectively, which voltages are different from voltages applied on signal lines other than those selected.

In S6, the light sensor circuit 212 performs a photoelectric conversion on the sensing data. That is, the reflected light detected by the photodiode 6 (light sensor element) is converted into current. The light sensor circuit 212 also amplifies the sensing data. That is, the sensor preamplifier 7 amplifies the voltage at the contact P (S7), and outputs the voltage to the sensor output amplifier 34 (S8).

In S9, the A/D conversion unit 150 performs an A/D conversion on the analog sensing data amplified by the sensor output amplifier 34, and outputs the digital data to a scan image generating unit 120. The scan image generating unit 120 generates scan images from digital data. In S10, the detected information analyzing unit 130 analyzes scan images generated by the scan image generating unit 120 based on the threshold data (recognition threshold 2) received from the recognition area control circuit 110, and extracts the coordinates of the location of the touch. Lastly, in S11, the detected information analyzing unit 130 outputs the extracted coordinates to the external host computer 10 as the detection result.

Benefits of Display Device 1000

As described above, the display device 1000 includes: the liquid crystal panel with built-in sensors 200 having the light sensor circuit 212; the detected information analyzing unit 130 determining the location on the front surface of the panel 200 touched by an object based on the light intensity distribution of the light detected by the light sensor circuit 212; the IR backlight 310 projecting light individually to the upper half and the lower half of backside of the panel surface; the recognition area control circuit 110 obtaining a recognition area data that instructs whether the location touched by an object on the upper half or lower half of the panel surface is subjected to detection by the detected information analyzing unit 130; and the BL control unit 111 instructing the IR backlight 310 to project a predetermined amount of light to the region specified in the recognition area data as being subjected to location detection by the detected information analyzing unit 130, and instructing the IR backlight 310 to project an amount of light that is less than the predetermined amount to the region specified in the recognition area data as not being subjected to location detection by the detected information analyzing unit 130.

Therefore, upon receipt of the recognition area data, which is properly set by the application running on the host computer 10, the recognition area control circuit 110 in the display device 1000 can instruct the IR backlight 310 to project a predetermined amount of light to the region that needs location detection, and can instruct the IR backlight 310 to project the amount of light that is less than the predetermined amount to the region that does not need location detection.

That is, the display device 1000 can reduce the backlight unit power consumption even when a user is touching the display screen to operate the application.

Additional Note

In the embodiments, the IR backlight 310 includes the light source 312a disposed over the liquid crystal panel with built-in sensors 200 and the light source 312b disposed below the liquid crystal panel with built-in sensors 200, where the light source 312a projects infrared light to the upper half of the liquid crystal panel with built-in sensors 200 and the light source 312b projects infrared light to the lower half of the liquid crystal panel with built-in sensors 200. However, the configuration of the IR backlight 310 is not limited to such. That is, the IR backlight 310 may be configured such that light sources are provided at N (N>2) locations, and the individual light sources project infrared light to different regions of the liquid crystal panel with built-in sensors 200.

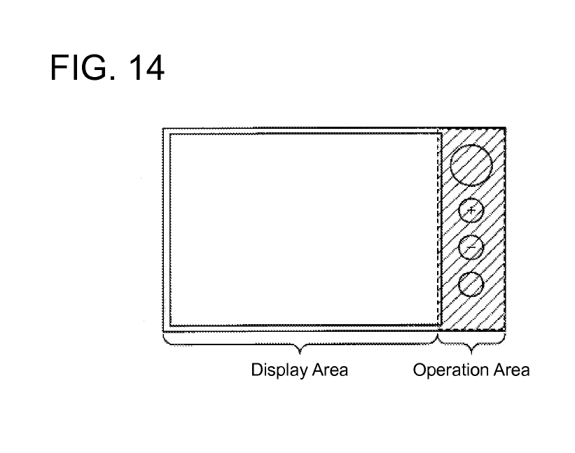

In this case, the recognition area control circuit 110 can control the on/off of individual light sources based on N-bit recognition area data instead of 2-bit data. Also, if the IR backlight 310 is configured to include light sources at Nl locations (Nl is a sufficiently large value), when, as shown in FIG. 14, the application UI uses a size ratio of the display area and the operation area that is not 1:1, the infrared light can still be adjusted so that the light will not be projected to the display area. Therefore, power consumption of the IR backlight 310 can be reduced approximately in proportion to the display area size.

Instead of the IR backlight 310, which projects infrared light, a backlight that emits other non-visible light such as ultraviolet light may be used to achieve the objective of the present invention.

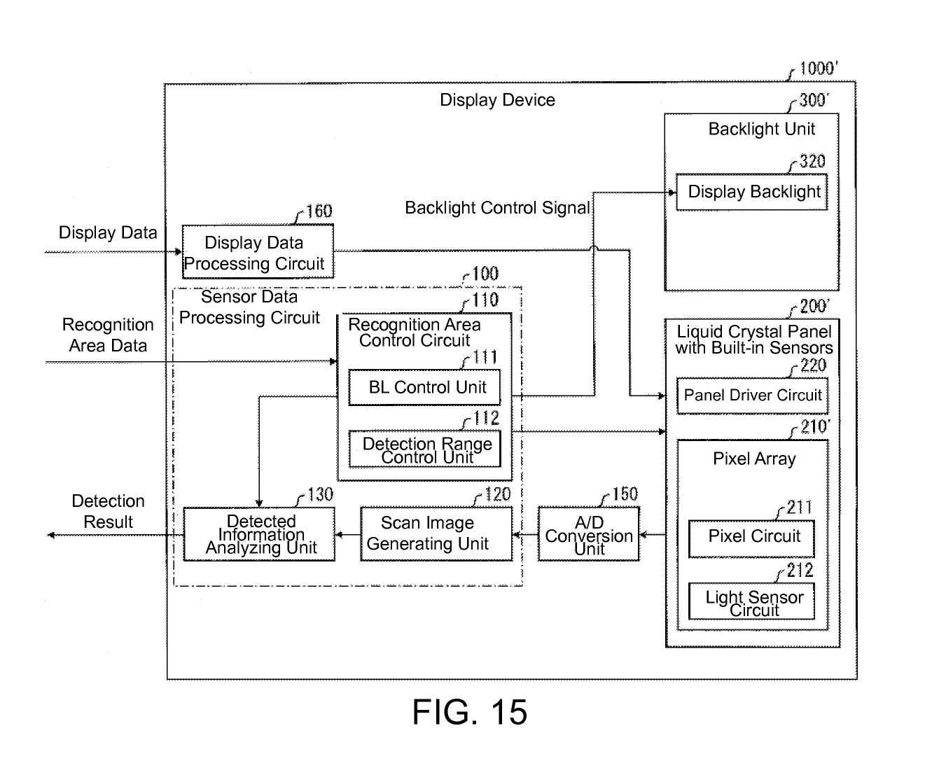

Alternatively, as shown in FIG. 15, the objective of the present invention can also be achieved with a display device 1000′ including: a backlight unit 300′ having a display backlight 320 only; and a liquid crystal panel with built-in sensors 200′ detecting reflected visible light emitted by the backlight unit 300′ for object image detection. That is, in this case, during the sensing period, the display device 1000′ has reduced amount of light projected by the display backlight 320 on a region of the liquid crystal panel with built-in sensors 200′ that is not used for the object image detection. Although this might give users some sense of discomfort about the liquid crystal display, but the reduction in the power consumption, which is the objective of the present invention, can be achieved.

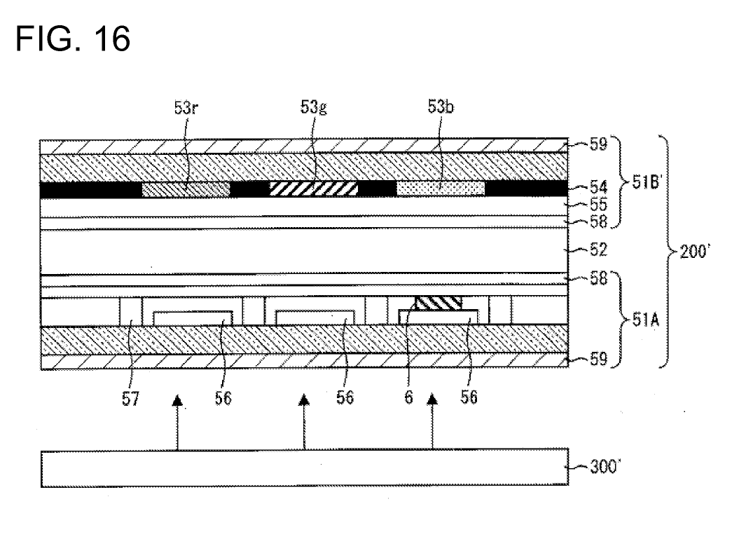

Also in this case, as shown in FIG. 16, the opposite substrate 51B′ of the liquid crystal panel with built-in sensors 200′ includes color filters 53r (red), 53g (green), and 53b (blue), a light-shielding film 54, an opposite electrode 55, an alignment film 58, a polarizing plate 59, and the like. The liquid crystal panel with built-in sensors 200′ also includes a backlight unit 300′ on its backside. The light that is projected from the display backlight 320 is transmitted through color filters 53r, 53g, and 53b. When light is projected from the display backlight 320, the light sensor circuit 212 including the photodiode 6 detects the light reflected by an object such as a finger during the sensing period.

In the embodiments described above, sensor control according to recognition area data is conducted. However, in the present invention, sensor control according to the recognition area data does not necessarily have to be conducted. That is, regardless of the value of the recognition area data, all light sensor circuits 212 may be allowed to operate.

Lastly, individual blocks included in the display device 1000 and the display device 1000′ may be configured according to the hardware logic. Also, the sensor data processing circuit 100 of the display devices 1000 and 1000′ may be controlled by a software, using a CPU (Central Processing Unit) as described below.

That is, the display devices 1000 and 1000′ only need to record the program code (executable program, intermediate code program, or source program) of the control program that conducts the controls of the sensor data processing circuit 100 in a computer-readable format. The display device 1000 (CPU or MPU) reads the program code recorded on the recording medium provided, and executes it.

Recording medium that supplies program codes to the display devices 1000 and 1000′ may be, for example, tapes such as magnetic tapes or cassette tapes; disks including magnetic disks such as floppy (registered trade mark) disks or hard disks, or optical disks such as CD-ROM, MO, MD, DVD, or CD-R; cards such as IC cards (including memory cards) or optical cards; or semiconductor memories such as mask ROM, EPROM, EEPROM, or flash ROM.

The display devices 1000 and 1000′ may also be configured to be connectable to a communication network to achieve the objective of the present invention. In this case, the above-mentioned program code is supplied to the display devices 1000 and 1000′ through the communication network. This communication network only needs to be able to supply the program code to the display devices 1000 and 1000′, and is not limited to any particular kind or form. It can be, for example, internet, intranet, extranet, LAN, ISDN, VAN, CATV communication network, mobile communication network, or satellite communication network.

Transmission media that constitute this communication network may be any media that can transmit the program code, and are not limited to any particular configuration or kind. Transmission media may be, for example, a wired system such as IEEE1394, USB (Universal Serial Bus), power line carrier, cable TV line, telephone line, or ADSL (Asymmetric Digital Subscriber Line) line; or a radio system such as infrared light system used for IrDA, remote controller, or the like, Bluetooth (registered trademark), 802.11 radio, HDR, portable telephone network, satellite line, or digital terrestrial network. The present invention can also be realized using computer data signals embedded in a carrier wave, in which the above-mentioned program code is presented in the form of electronic transmission.

Preferably, the display device of the present invention further includes an obtaining element that obtains recognition area data instructing, for each of the regions, whether an object in contact with a relevant region is subjected to location detection by the location detection element, and the light emission control element controls the backlight so that the backlight projects a predetermined amount of light to the region specified in the recognition area data as being subjected to location detection by the location detection element, and so that the backlight projects an amount of light that is less than the predetermined amount to the region specified in the recognition area data as not being subjected to location detection by the location detection element.

According to the configuration described above, the display device can instruct the light-emitting unit to project an amount of light smaller than a predetermined light amount to the region specified in the recognition area data as not being subjected to location detection of a contacting object by a location detection element.

Therefore, when an application that does not require location detection in a particular region of the display panel is running on an external computer, if the computer sends the recognition area data to the display device, the display device can reduce the backlight power consumption even when a user is touching the display screen to use the application.

Preferably, in a display device of the present invention, the light emission control element instructs the backlight to project light, which light is at least less intense, less frequently emitted, or emitted for a shorter period of time than the predetermined amount of light, to a region other than the particular region of the plurality of regions.

Also preferably, in a display device of the present invention, when the light emission control element instructs the backlight to project light to a region other than the particular region of the plurality of regions, a current that flows at least with a smaller amplitude, with a lower pulse frequency, or for a shorter period of time than the current necessary for the backlight to project the predetermined amount of light is supplied to the backlight.

Preferably, in a display device of the present invention, the current that the light emission control element supplies to the backlight to project light to the particular region of the plurality of regions flows at least with a larger amplitude, with a higher pulse frequency, or for a longer period of time than the current necessary to project the predetermined amount of light, as long as the total light amount the entire display panel would receive from this current is smaller than the total light amount the entire display panel would receive from the current for said predetermined light amount.

Also preferably, in a display device of the present invention, the location detection element includes: an image generating element that generates an image having pixel values representing the light intensity distribution; and an extracting element that extracts a pixel in the image that has a pixel value at least as high as a predetermined threshold, wherein the extracting element extracts a pixel whose pixel value is at least as high as threshold 1 when the light emission control element projects the predetermined amount of light to the entire display panel, and extracts a pixel whose pixel value is at least as high as threshold 2, which is lower than threshold 1, when the predetermined amount of light is not projected to any region of the plurality of regions.

According to each of the configurations described above, a display device of the present invention provides an additional effect that any decrease in accuracy of the location detection caused by the reduced amount of the light leaked from the light-emitting unit instructed not to project the predetermined amount of light to the region subjected to the location detection by the location detection element can be suppressed.

Preferably, in a display device of the present invention, for each of the regions, the light sensor is configured to be capable of detecting the intensity of light coming through the region, and the light emission control element instructs the light sensor not to detect the intensity of light entering through the region of the plurality of regions that is not irradiated with the predetermined amount of light projected from the backlight.

According to the configuration described above, a display device of the present invention provides an additional effect that it can reduce the light sensor power consumption, because the light sensor is not instructed to detect the light intensity.

In a display device according to the present invention, the light emitted by the backlight described above preferably includes non-visible light.

According to the configuration described above, a display device of the present invention provides an additional effect that the backlight power consumption can be reduced without influencing the clarity of the image displayed on the display panel by the light projected from the backlight.

Also, in a display device of the present invention, the above-mentioned backlight may be a display backlight that projects visible light to display images on the above-mentioned display panel.

According to the configuration described above, a display device of the present invention provides additional effects that it can reduce the backlight power consumption even when it is realized as a display device having a display backlight as the only backlight.

Also, a display method according to the present invention may include a location detection process in which the location on the front surface of the display panel that is touched by an object is determined based on the light intensity distribution obtained by the light sensor of the display device.

Also, programs instructing a computer to function as individual functional elements of a display device of the present invention, and recording media on which those programs are recorded and are readable by computers are also within the scope of the present invention.

The present invention is not limited to the embodiments described above. Various modifications can be made within the scope defined by the appended claims. That is, any embodiments obtained by combinations of appropriate modifications of technical means within the scope defined by the claims are also included in the technical scope of the present invention.

### INDUSTRIAL APPLICABILITY

The present invention can suitably be used for computers with a display screen having data entry capability, PDAs, portable phones, and the like, in particular.

### DESCRIPTION OF REFERENCE CHARACTERS

1000 display device
1000′ display device
100 sensor data processing circuit (location detection element)
110 recognition area control circuit (obtaining element)
111 BL control unit (light emission control element)
112 detection range control unit
120 scan image generating unit (image generating element)
130 detected information analyzing unit (extracting element)
200 liquid crystal panel with built-in sensors (display panel)
210 pixel array
210′ pixel array
211 pixel circuit
212 light sensor circuit
220 panel driver circuit
300 backlight unit
300′ backlight unit
310 IR backlight (backlight)
311a, 311b LED power supply
312a, 312b light source
320 display backlight

1. A display device comprising:
a display panel with built-in light sensors detecting an incoming light intensity distribution;
a location detection element determining a location of a touch by an object on front surface of said display panel based on the light intensity distribution detected by said light sensors;
a backlight that can project light individually to a plurality of regions constituting a panel surface of said display panel from behind the panel, and
a light emission control element controlling said backlight such that a prescribed amount of light is projected to a particular region of said plurality of regions, and that an amount of light smaller than the prescribed amount is projected to a region other than said particular region of the plurality of regions.

2. The display device according to claim 1, further comprising an obtaining element that obtains recognition area data specifying, for each of the regions, whether an object in contact with a relevant region is subjected to location detection by said location detection element,
wherein said light emission control element controls the backlight so that the backlight projects a predetermined amount of light to the region specified in the recognition area data as being subjected to location detection by said location detection element, and so that the backlight projects an amount of light that is less than the predetermined amount to the region specified in the recognition area data as not being subjected to location detection by said location detection element.

3. The display device according to claim 1,
wherein said light emission control element instructs said backlight to project light, which light is at least less intense, less frequently emitted, or emitted for a shorter period of time than said predetermined amount of light, to a region other than said particular region of the plurality of regions.

4. The display device according to claim 1,
wherein when said light emission control element instructs said backlight to project light to a region other than said particular region of the plurality of regions, a current that flows at least with a smaller amplitude, with a lower pulse frequency, or for a shorter period of time than the current necessary for said backlight to project the predetermined amount of light is supplied to the backlight.

5. The display device according to claim 1,
wherein when said light emission control element instructs said backlight to project light to said particular region of the plurality of regions, current that said light emission control element supplies to said backlight flows in at least one of the following conditions: with a larger amplitude, with a higher pulse frequency, or for a longer period of time, than the current necessary to project said predetermined light amount, such that the total light amount the entire display panel receives from this current is smaller than the total light amount the entire display panel would receive from said current for said predetermined light amount.

6. The display device according to claim 1,
wherein said location detection element includes: an image generating element that generates an image having pixel values representing the light intensity distribution; and an extracting element that extracts a pixel in the image that has a pixel value at least as high as a predetermined threshold, and
wherein said extracting element extracts a pixel whose pixel value is at least as high as threshold 1 when said light emission control element projects said predetermined amount of light to the entire display panel, and extracts a pixel whose pixel value is at least as high as threshold 2, which is lower than threshold 1, when said predetermined amount of light is not projected to any region of the plurality of regions.

7. The display device according to claim 1,
wherein, for each of the regions, said light sensor is configured to be able to detect the intensity of light entering through the region, and
wherein said light emission control element instructs said light sensor not to detect the intensity of light entering through the particular region of the plurality of regions, which is not irradiated with said predetermined amount of light projected from said backlight.

8. The display device according to claim 1, wherein the light emitted by said backlight includes non-visible light.

9. The display device according to claim 1, wherein said backlight is a display backlight that emits visible light to display images on said display panel.

10. A display method of a display device including a backlight that can project light individually to a plurality of regions constituting a panel surface of a display panel with built-in light sensors from behind, said sensors detecting incoming light intensity distribution, the method comprising:
a light emission control process in which said backlight is instructed to project light to said display panel,
wherein a predetermined amount of light is projected to a particular region of said plurality of regions, and a smaller amount of light is projected to a region except for said particular region of the plurality of regions.

11. The display method according to claim 10, further comprising a location detection process in which the location on a front surface of said display panel that is touched by an object is determined based on the light intensity distribution detected by said light sensor.

12. A display program instructing a computer to function as individual functional elements of the display device according to claim 1.

13. A recording medium on which the display program according to claim 12 is recorded, which medium is readable by computers.
